(19) United States
(12) Patent Application Publication
(10) Pub. No.: US 2025/0368389 A1
(43) Pub. Date: Dec. 4, 2025

(54) A PALLET AND A METHOD OF MANUFACTURING THEREOF

(71) Applicant: X-Tyre Global (Pty) Limited, Johannesburg (ZA)

(72) Inventor: Oscar Filen, Johannesburg (ZA)

(21) Appl. No.: 19/104,794

(22) PCT Filed: Aug. 22, 2023
(86) PCT No.: PCT/ZA2023/050051

§ 371 Date: Feb. 19, 2025

(30) Foreign Application Priority Data
Aug. 22, 2022 (ZA) 2022/09701

(51) Int. Cl. B65D 19/00; B29C 43/18; B29K 105/26; B29L 31/00; C09D 5/14; C09D 133/04

(52) U.S. Cl. CPC B65D 19/0038; B29C 43/18; C09D 5/14; C09D 133/04; B29C 2043/189; B29K 2105/26; B29L 2031/7178; B65D 2519/00034; B65D 2519/00069; B65D 2519/00273; B65D 2519/00288; B65D 2519/00303; B65D 2519/00318; B65D 2519/00333; B65D 2519/00373; B65D 2519/00467; B65D 2519/00472; B65D 2519/00572; B65D 2519/00825; B65D 2519/00985

(57) ABSTRACT

A dismantlable pallet including a substantially planar, upper load bearing member with a reinforcing internal frame; a substantially planar, lower supporting base with a reinforcing internal frame configured to improve the structural rigidity and load bearing capacity of the base. The pallet further includes a plurality of spaced apart support members sandwiched between the load bearing member and the base defining apertures between the load bearing member and the base, rendering the pallet releasably engageable with conventional and compatible load transporting apparatuses; and at least one releasable fastener to secure the load bearing member to the base with their respective reinforcing internal frames and the support members sandwiched between the member and the base wherein the load bearing member and the base are made of a rubber compound selected from the group including hardness, tensile strength, tear resistance, abrasion resistance, temperature resistance, impact resistance, slip resistance and moisture resistance.

### FIELD OF THE INVENTION

The invention relates to a pallet and a method of manufacturing thereof. More particularly but not exclusively, the invention relates to a dismantlable pallet with modular components and enhanced physical properties and performance capabilities and a method of manufacturing such pallet.

### BACKGROUND TO THE INVENTION

It has become commonplace in industries such as transport and manufacturing to use pallets when moving and/or storing goods. Generally, a pallet comprises of a rectangular platform that supports goods above a support surface such as a floor or in a rack. Pallets typically include openings on at least one side for receiving the forks of a material handling vehicle such as a forklift or crane attachment and provides a means for securing and strapping goods to the pallet. For improved working flexibility, modern pallets are typically designed to have fork access from all four vertical sides.

Pallets are traditionally constructed from wood and/or composite wood materials. Pallets constructed from wood are typically made up from a plurality of wood pieces fixed to each other by screws, nails and/or other suitable fastening means. Despite their extensive use, these conventional pallets present various shortcomings that limit their utilisation and useful life. Wooden pallets, being constructed by assembling several wood pieces, have the inconvenience of being subject to the development of clearances between the components at their respective fixing points, which causes them to become mis-aligned after repetitive use, rendering them fragile and unstable. Over time, the misalignment and instability greatly diminish the useful life of these pallets.

Further shortcomings of wooden pallets relate to the wood itself. Wood might offer satisfactory mechanical strength for certain applications, but it has a low resistance to ambient conditions, especially with relatively high levels of moisture, as it causes decay in the wood and, as a consequence, the loss of the pallet as a whole. Moreover, when exposed to moisture, wooden pallets can warp, becoming uneven and often unsuitable for its intended uses. Wood as a material is also susceptible to an attack and infestation of pests such as termites that lead to further decay in the wood pallets. This susceptibility also leads to an increase in the associated manufacturing and running costs of these pallets, as they need to be fumigated or otherwise treated to mitigate the risks of these pests. Wooden pallets further pose a significant fire hazard in large storage and manufacturing facilities due to their flammable nature. In the event of a fire outbreak, these pallets can ignite quickly and intensify the flames, potentially leading to substantial damage and endangering the safety of both personnel and valuable goods or other assets.

The conditions under which many modern pallets are used are particularly hazardous and robust. Pallets are not only subjected to heavy loads and stresses from strapping but are also regularly impacted, and slid and moved around storage and/or manufacturing facilities. Such usage regularly results in damage that might render a pallet unusable. In addition, splintered wood and loose fasteners such as nails can also damage the goods loaded on the pallets during the loading and/or unloading process. Lastly, the final disadvantage of wooden pallets concerns sustainability and environmental preservation. The use of wood in the construction of pallets causes deforestation and negatively impacts the environment.

In an effort to address the above shortcomings with wooden pallets, alternative materials such as plastic and/or metal have been used in the construction of pallets. However, attempts to overcome the drawbacks of ordinary wooden pallets with plastic pallets have also faced shortcomings. Plastic pallets have the advantage of being lighter than wood, and easier to keep clean and hygienic. However, prior designs of plastic pallets have had to deal with issues such as the trade-off between cost and weight bearing capability. Typically, plastic pallets designed with a significant weight bearing capability tend to be both heavy and expensive. In the same manner, inexpensive plastic pallets have typically lacked both strength and durability. Plastic pallets have also exhibited limitations in terms of temperature resistance, making them susceptible to deformation when exposed to relatively high ambient temperatures. In addition, existing plastic pallets often have slippery surfaces, due to the inherent nature of the plastics materials that have traditionally been used for this purpose. Moreover and unlike wooden pallets, plastic pallets are exceedingly difficult to repair and, once unusable, are typically disposed of and replaced. Furthermore and although plastic pallets are recyclable, studies have shown that less than 10% of recycled plastics make their way back into products.

Another alternative pallet material is metal or metal alloys. While metal pallets offer advantages such as durability and strength, they are not without their own drawbacks. One significant disadvantage lies in their high cost, making them an expensive option for businesses seeking cost-effective, goods handling solutions. Metal pallets further often lack resilience and flexibility, rendering them vulnerable to warping and/or deformation under heavy loads or harsh environmental conditions. Once warped, these pallets become unusable, leading to additional expenses and wastage.

In recent times, society has demanded significant efforts on continuing the development of more environmentally friendly methods for reusing various synthetic and plastic materials. However, the use of plastic has shown to be detrimental to the environment, both in its manufacturing and especially in the disposal thereof. It is therefore desirable to provide a long-life pallet having outstanding physical attributes that is relatively inexpensive and can be manufactured with relative ease. Specifically, it is desirable to provide a low-cost pallet that meets and exceeds stringent strength and design standards while being configured to be easily stacked and rackable during periods of non-use and transportation.

In addition and in today's modern manufacturing and storage facilities, efficient tracking and seamless identification of goods and materials have become paramount. Conventional pallets on the market fail to provide for or incorporate intelligent technologies that enable real-time tracking and compatibility with automated systems, such as scanners and robots. As a result, businesses face challenges in optimizing their material handling processes and have to resort to the manual identification and/or management of the goods in these facilitates.

### Object of the Invention

It is accordingly an object of the invention to provide a novel, environmentally sustainable, cost-effective pallet with enhanced physical properties and performance capabilities and a method of manufacturing thereof, or at least an alternative to the existing pallets that are available.

### SUMMARY OF THE INVENTION

According to the first aspect of the invention there is provided a dismantlable pallet for the storage and transportation of goods, the pallet comprising:
a substantially planar, upper load bearing member, provided with a reinforcing internal frame that is configured to improve the structural rigidity and load bearing capacity of the member;
a substantially planar, lower supporting base, provided with a reinforcing internal frame that is configured to improve the structural rigidity and load bearing capacity of the base;
at least one support member, sandwiched between the load bearing member and the base, thereby reducing the weight of the pallet while defining apertures between the load bearing member and the base, rendering the pallet releasably engageable with conventional and compatible load transporting apparatus; and
at least one releasable fastener, configured to secure the load bearing member to the base at a predetermined distance with their respective reinforcing internal frames and the support member sandwiched between the member and the base to provide a dismantlable, reinformed, pallet-like structure;
   the load bearing member and the base being made of a material comprising a rubber compound with preselected physical properties selected from a group comprising, hardness, tensile strength, tear resistance, abrasion resistance, temperature resistance, impact resistance, slip resistance and moisture resistance.

The pallet may be provided with a set of support members, spaced apart in a predetermined configuration to provide optimum support to the load bearing member while offering predetermined apertures between the load bearing member and the base to render the pallet releasably engageable with conventional and compatible load transporting apparatus.

The pallet may be provided with an integrated cavity configured to securely house a conventional electronic communication device therein.

The pallet may be provided with a set of releasable fasteners, configured to secure the load bearing member to the base with their respective reinforcing internal frames and the set of support members sandwiched between the member and the base.

The load bearing member and the base may comprise a rubber compound. Preferably, the load bearing member and the base comprise a recycled rubber compound such as discarded tyres.

The recycled compressed rubber compound may comprise a mixture of:
recycled rubber selected from a group including, natural rubber, styrene-butadiene rubber, polybutadiene and butyl rubber and the like; and
a binder selected from a group including, polyurethanes, epoxies, neoprene, nitrile, silicone, polymers, elastomers and the like.

Preferably, the recycled rubber compound comprises a mixture of recycled rubber and a medium viscosity, solvent free, moisture curing isocyanate binder. More preferably, the recycled rubber compound comprises a mixture of recycled rubber obtained from discarded tyre materials and a medium viscosity, solvent free, moisture curing isocyanate binder.

The reinforcing frames may comprise at least one U-beam shaped, longitudinally extending inner member, with a substantially concave channel along its inner surface, wherein the respective open-ends of the inner member are provided with outwardly protruding flanges extending perpendicularly relative to the main body of the member.

The reinforcing frames may comprise of a rigid material selected from metal, plastic, fibreglass and the like. Preferably, the reinforcing frame comprises metal.

The pallet may be configured to be modular wherein the load bearing member, the support members and base are dismantlable and removably attachable to one another, thereby facilitating dismantlability, assembly, disassembly, replacement of components and customization of the pallet.

The releasable fastener may comprise a nut-and-bolt arrangement.

The pallet may be provided with an anti-microbial coating selected from a group including, acrylic-, silver-, copper-, zinc- and bio-based coatings. Preferably the pallet is provided with acrylic-based anti-microbial coating.

The pallet may be configured to have a maximum load bearing capacity of between 5 tonnes 25 and 20 tonnes. Preferably the pallet is configured to have a maximum load bearing capacity of 10 tonnes.

The pallet may be configured to withstand ambient temperatures between −70° C. and 200° C. without undergoing substantial structural degradation and loss of performance. Preferably, the pallet is configured to withstand ambient temperatures between −40° C. and 140° C. without undergoing substantial structural degradation and loss of performance.

The electronic communication device may be configured to transmit and receive data. Preferably, the electronic communication device is configured to:
receive GPS signals to determine and transmit the geographical location of the pallet; and
store and transmit identification data associated with the pallet.

The electronic communication device may be configured to:
receive data from compatible electronic communication devices linked to the goods that are loaded onto the pallet;
identify the goods that are loaded onto the pallet;
determine the number of goods that are loaded onto the pallet; and
store and transmit the identification and quantity data associated with the goods.

According to the second aspect of the invention there is provided a method of manufacturing a pallet, the method including the steps of:
filling a mould with a mixture of a rubber compound and a binder;
positioning a frame within the mixture;
heating and compressing the mixture with a hydraulic press;
removing the compressed rubber component from the mould; and
attaching a plurality of support members to predetermined positions on the component; and
attaching a second internally reinforcing, compressed rubber component to the support members.

The method may include the steps of:
securing an electronic communications device within a cavity on the pallet; and
coating the pallet with an anti-microbial coating.

### DETAILED DESCRIPTION OF THE INVENTION

A non-limiting embodiment of the invention shall now be described with referenced to the accompanying drawings wherein:

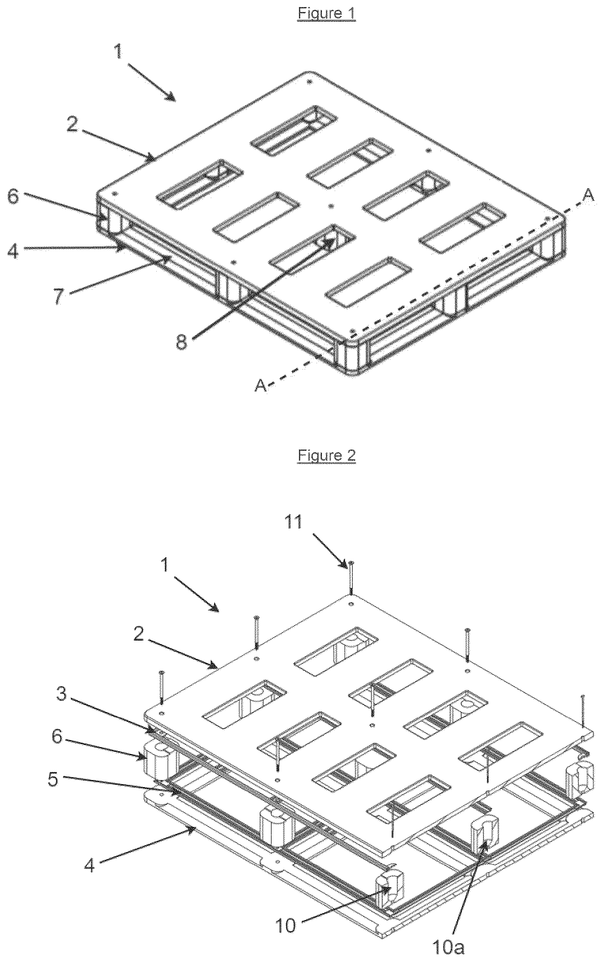

FIG. 1 is a perspective view of a pallet in accordance with the invention;

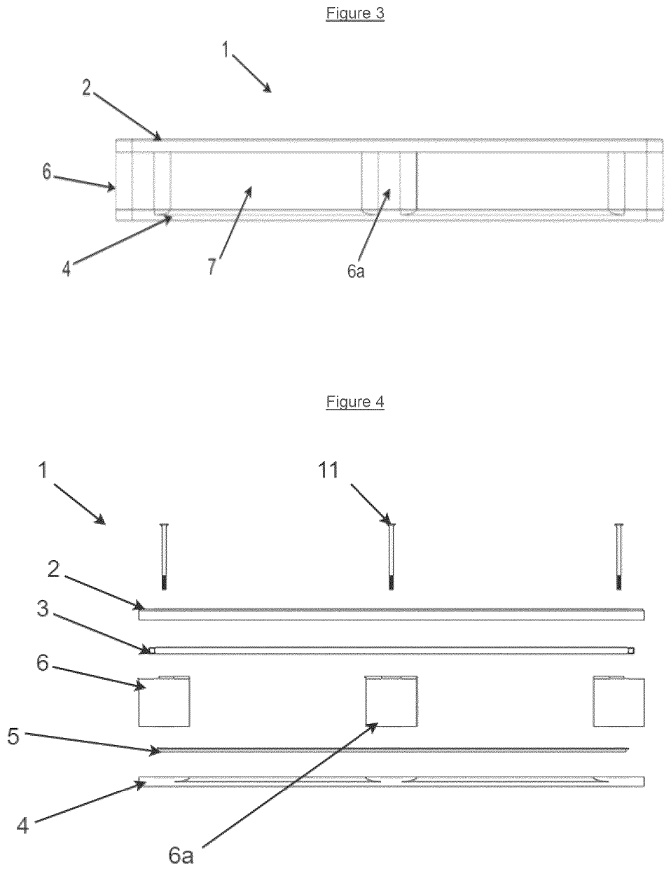

FIG. 2 is an exploded view of the pallet, cut along the line A-A, as illustrated in FIG. 1;

FIG. 3 is a side view of the pallet, as illustrated in FIG. 1;

FIG. 4 is an exploded side view of the pallet, as illustrated in FIG. 1;

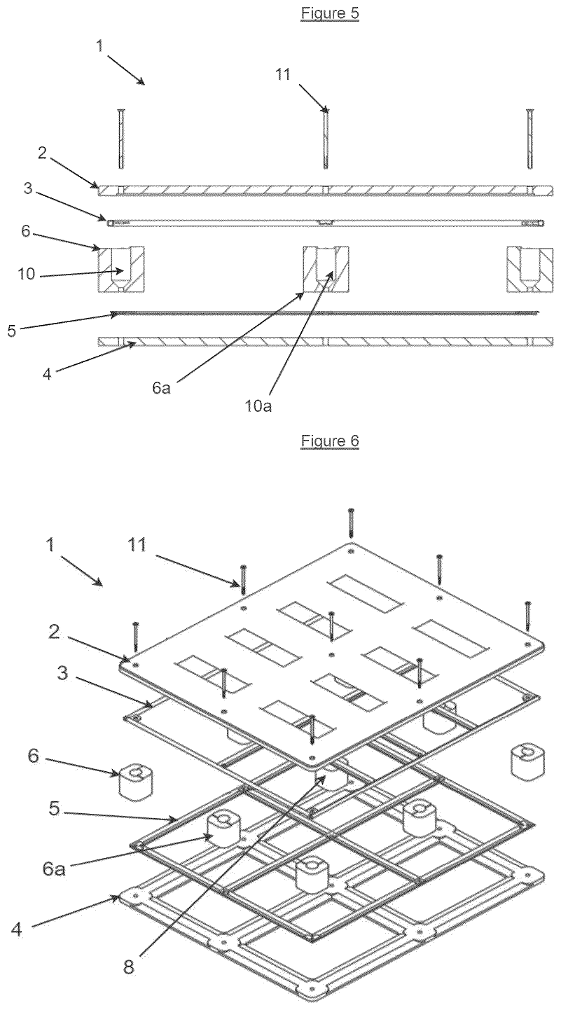

FIG. 5 is an exploded side view of the pallet, cut along the line A-A, as illustrated in FIG. 1;

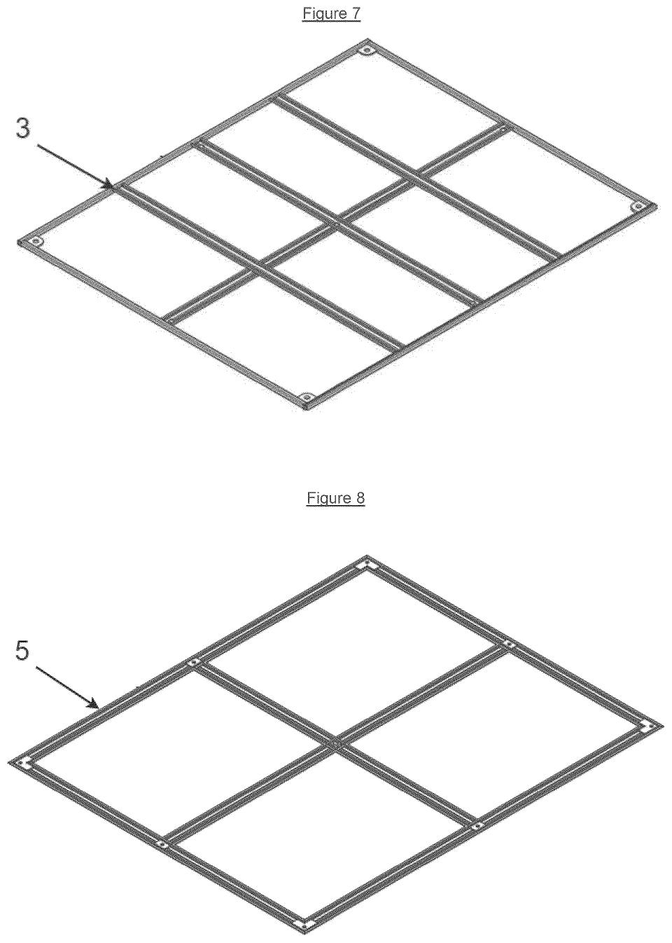

FIG. 6 is a further exploded view of the pallet, as illustrated in FIG. 1;

FIG. 7 is a perspective view of the reinforcing internal frame of the load bearing member of the pallet, as illustrated in FIG. 1;

FIG. 8 is a perspective view of the reinforcing internal frame of the supporting base of the pallet, as illustrated in FIG. 1;

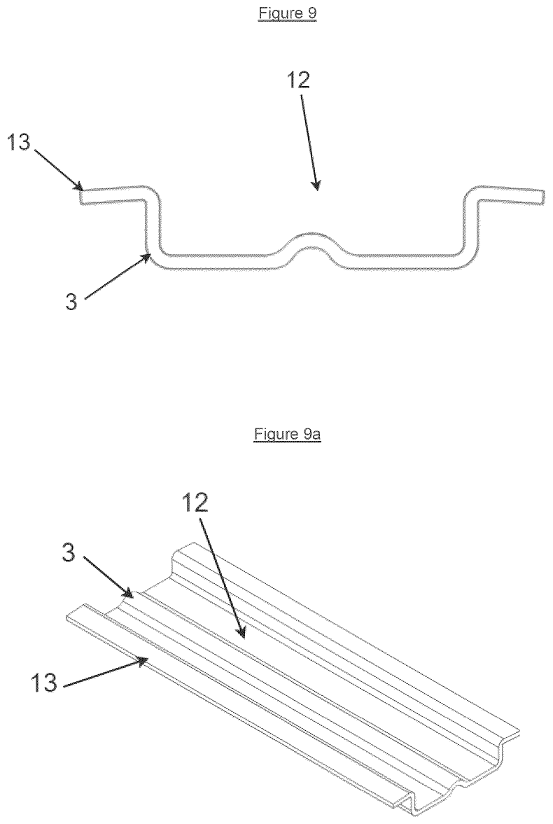

FIG. 9 is a cross-sectional view of the reinforcing internal frame, as illustrated in FIG. 1;

FIG. 9a is a perspective view of an inner member of the reinforcing internal frame, as illustrated in FIG. 1;

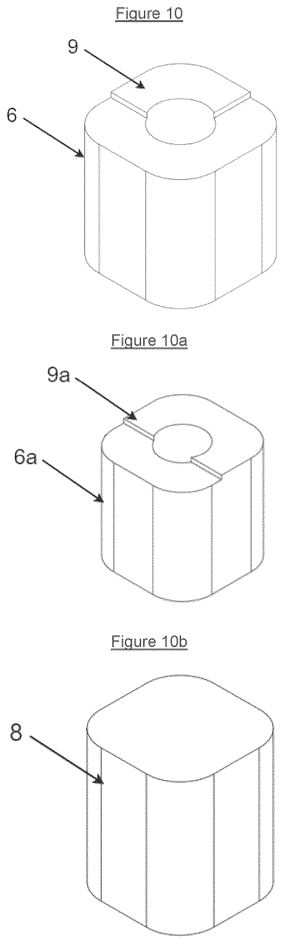

FIG. 10 is a perspective view of the corner support member of the pallet, as illustrated in FIG. 1;

FIG. 10a is a perspective view of the middle support member of the pallet, as illustrated in FIG. 1; and

FIG. 10b is a perspective view of the central support member of the pallet, as illustrated in FIG. 1.

A pallet 1 as illustrated in FIGS. 1 to 10b comprises a substantially planar, upper load bearing member 2, provided with a reinforcing internal frame 3 and a substantially planar, lower supporting base 4, provided with a reinforcing internal frame 5, wherein both of the internal frames are configured to improve the structural rigidity and load bearing capacity of the pallet.

The pallet 1 is further provided with a number of spaced apart support members 6, 6a, that are sandwiched between the load bearing member 2 and the base 4, defining apertures 7 between the load bearing member and the base, wherein the apertures are configured to be releasably engageable with conventional and compatible load transporting apparatuses. The apertures 7 are configured to engageably receive the forks of goods handling vehicles such as forklifts or crane attachments, and/or it provides a means for securing and strapping goods to the pallet 1. The pallet is also provided with an extended central support member 8 that further improves the structural rigidity and load bearing capacity of the pallet 1.

The support member 6, 6a are provided with a stepped upper formation 9, 9a configured to counteract any rotational forces that could arise when the pallet 1 bears substantial loads. Furthermore, each of the support members 6, 6a incorporates enlarged central cavities 10, 10a, configured to reduce their overall weight while maintaining structural strength and robustness.

The pallet 1 is configured to be dismantlable and modular wherein the load bearing member 2, support members 6, 6a and base 4 are removably attachable to one another, thereby facilitating dismantlability, assembly, disassembly, replacement of components and customization of the pallet. The load bearing member 2 with its reinforcing internal frame 3, support members 6 and supporting base 4 with its reinforcing internal frame 5 are securely fastened to each other with a nut-and-bolt arrangement 11 with the nut traversing from the load bearing member through to the base. The nut-and-bolt arrangement 11 allows the pallet 1 to be easily assembled and disassembled enabling efficient replacement of individual components and optimizing storage utilization and transportation.

The pallet 1 is further provided with an integrated cavity (not shown) configured to securely house a conventional electronic communication device (not shown) therein. The electronic communication device (not shown) is configured to transmit and receive data including, GPS signals to determine and transmit the geographical location of the pallet 1, and store and transmit identification data associated with the pallet. This enables the pallet 1 to be tracked in real time and compatibility with automated systems, such as RFID scanners and industrial robots used in various manufacturing, goods handling and storage applications. The electronic communication device (not shown) enables users to optimize their material handling and management processes and systems.

The pallet is constructed using a resilient, flexible, high tensile strength, abrasion resistant, temperature resistant, high-density compressed rubber compound. The rubber compound comprises a mixture of the recycled rubber compound, such as the recycled rubber obtained from discarded tyre materials, and a medium viscosity, solvent free, moisture curing isocyanate binder. The rubber compound has preselected physical including, hardness, tensile strength, tear resistance, abrasion resistance, temperature resistance, impact resistance, slip resistance and moisture resistance.

The reinforcing frames 3, 5 comprises inner U-beam shaped, longitudinally extending members, configured to provide increase structural support and stability. The U-beam configuration includes a substantially concave channel 12 along the inner surface, bolstering the frames' 3, 5 ability to withstand external forces and pressures. At each open-end of the U-beam members, outwardly protruding flanges 13 are integrated, extending perpendicularly relative to the main body of the members. The flanges strengthen the frames 3, 5 lending it rigidity and resistance against deformation. The frames 3, 5 are constructed from a suitable rigid material such as steel and/or an alternative metal alloy.

The pallet 1 is also provided with an acrylic-based anti-microbial. The coating prevents the growth and spread of harmful microorganisms, such as bacteria and viruses, thereby making the pallet suitable for storing items that are sensitive to contamination, such as food and medical products, as it prevents contamination and ensures a hygienic environment for storing such goods.

The pallet 1 is configured to have a maximum load bearing capacity between 5 and 20 tonnes. Furthermore, the pallet 1 is configured to withstand ambient temperatures between −100° C. and 120° C. without undergoing substantial structural degradation and loss of performance.

To manufacture the load bearing member 2, a suitable mould is coated with a release agent, after which the mould is filled with a mixture of a rubber compound comprising recycled rubber obtained from discarded tyre materials, and a medium viscosity, solvent free, moisture curing isocyanate binder. Thereafter a reinforcing frame is positioned within the mixture and the mixture is heated and compressed with a hydraulic press. After a predetermined amount of time has passed, the press is removed, and the load bearing member is ejected from the mould. This process is repeated in order to manufacture the supporting base 4. The pallet 1 is constructed by firstly mechanically bolting and gluing the support members 6, 6a, 8 to the base, and then similarly bolting the load bearing member 2 to the support members. Once the pallet 1 has been constructed, an electronic communication device is secured in the cavity (not shown), and the pallet is coated with an anti-microbial coating.

The present invention utilizes recycled tyre rubber as a key material in the manufacturing of the pallet 1, offering significant environmental advantages over conventional production methods. By repurposing discarded tyre rubber, the invention contributes to reducing the environmental burden associated with tyre waste disposal, thereby promoting sustainable waste management practices. Recycling tyre rubber also helps in conserving valuable natural resources such as wood that would have been used in the production of traditional pallets. Moreover, the incorporation of recycled tyre rubber into the manufacturing process leads to a reduction in greenhouse gas emissions and energy consumption, aligning with eco-friendly initiatives and minimizing the overall carbon footprint.

It will be appreciated that many variations in detail are possible without departing from the scope and/or spirit of the inventions as defined in the consistory statements and/or as described in the specific embodiments hereinabove.

A full listing of the claims follows:

1. A dismantlable pallet for the storage and transportation of goods, the pallet comprising:
a substantially planar, upper load bearing member, comprising a first reinforcing internal frame configured to improve structural rigidity and load bearing capacity of the member;
a substantially planar, lower supporting base, comprising a second reinforcing internal frame configured to improve structural rigidity and load bearing capacity of the base;
wherein the first and second reinforcing internal frames comprise at least one U-beam shaped, longitudinally extending inner member,
at least one support member, sandwiched between the load bearing member and the base, thereby reducing weight of the pallet while defining apertures between the load bearing member and the base,
wherein the pallet is releasably engageable with conventional and compatible load transporting apparatus;
at least one releasable fastener, configured to secure the load bearing member to the base at a predetermined distance;
wherein the first and second reinforcing internal frames and the support members are sandwiched between the member and the base to provide a dismantlable, reinformed, pallet structure; and
wherein the load bearing member and the base are made of a material comprising a rubber compound with preselected physical properties selected from the group consisting of hardness, tensile strength, tear resistance, abrasion resistance, temperature resistance, impact resistance, slip resistance and moisture resistance.

2. The pallet as claimed in claim 1, wherein the pallet further comprises a set of support members, spaced apart in a predetermined configuration to provide optimum support to the load bearing member while offering predetermined apertures between the load bearing member and the base to render the pallet releasably engageable with conventional and compatible load transporting apparatus.

3. The pallet as claimed in claim 1, wherein the pallet further comprises an integrated cavity and an electronic communication device.

4. The pallet as claimed in claim 1, wherein the pallet comprises a set of support members, spaced apart in a predetermined configuration to provide optimum support to the load bearing member while offering predetermined apertures between the load bearing member and the base to render the pallet releasably engageable with conventional and compatible load transporting apparatus, and a set of releasable fasteners, configured to secure the load bearing member to the base with their respective reinforcing internal frames and the set of support members sandwiched between the member and the base.

5. (canceled)

6. The pallet as claimed in claim 1, wherein the load bearing member and the base comprise a recycled rubber compound.

7. The pallet as claimed in claim 6, wherein the recycled rubber compound comprises a mixture of:
recycled rubber selected from the group consisting of natural rubber, styrene-butadiene rubber, polybutadiene and butyl rubber; and
a binder selected from the group consisting of polyurethanes, epoxies, neoprene, nitrile, silicone, polymers, and elastomers.

8. The pallet as claimed in claim 6, wherein the recycle rubber compound is obtained from discarded tyre materials, and wherein the recycled rubber compound comprises a mixture of recycled rubber and a medium viscosity, solvent free, moisture curing isocyanate binder.

9. (canceled)

10. The pallet as claimed in claim 1, wherein the at least one U-beam shaped, longitudinally extending inner member includes a substantially concave channel along its inner surface, wherein respective open-ends of the inner member are provided with outwardly protruding flanges extending perpendicularly relative to the main body of the member to lend rigidity and load bearing capacity.

11. The pallet as claimed in claim 1, wherein the reinforcing internal frames comprise a rigid material selected from the group consisting of metal, plastic, and fibreglass.

12. The pallet as claimed in claim 1, wherein the load bearing member, the support members and base are dismantlable and removably attachable to one another, thereby facilitating dismantlability, assembly, disassembly, replacement of components and customization of the pallet.

13. The pallet as claimed in claim 1, wherein the releasable fastener comprises a nut-and-bolt arrangement.

14. The pallet as claimed in claim 1, wherein the pallet is provided with an anti-microbial coating selected from the group consisting of acrylic-, silver-, copper-, zinc- and bio-based coatings.

15. The pallet as claimed in claim 1, wherein the pallet is provided with acrylic-based anti-microbial coating.

16. The pallet as claimed in claim 1, wherein the pallet has a maximum load bearing capacity of between 5 tonnes and 20 tonnes.

17. (canceled)

18. The pallet as claimed in claim 1, wherein the pallet withstands ambient temperatures between −70° C. and 200° C. without undergoing substantial structural degradation and loss of performance.

19. (canceled)

20. The pallet as claimed in claim 3, wherein the electronic communication device transmits and receives data.

21. The pallet as claimed in claim 3, wherein the electronic communication device
receives GPS signals to determine and transmit a geographical location of the pallet; and
stores and transmits identification data associated with the pallet.

22. The pallet as claimed in claim 3, wherein the electronic communication device
receives data from compatible electronic communication devices linked to goods that are loaded onto the pallet;
identifies goods that are loaded onto the pallet;
determines a number of goods that are loaded onto the pallet; and
stores and transmits identification and quantity data associated with the goods.

23. A method of manufacturing a pallet, the method comprising the steps of:
filling a mould with a mixture of a rubber compound and a binder;
positioning a frame within the mixture;
heating and compressing the mixture with a hydraulic press to produce a first compressed rubber component;
removing the first compressed rubber component from the mould;
attaching a plurality of support members to predetermined positions on the first compressed rubber component; and
attaching a second compressed rubber component to the support members.

24. The method as claimed in claim 23, wherein the method further comprises the steps of:
securing an electronic communications device within a cavity on the pallet; and
coating the pallet with an anti-microbial coating.
